(19) United States
(12) Patent Application Publication
(10) Pub. No.: US 2010/0142754 A1
(43) Pub. Date: Jun. 10, 2010

(54) INSPECTION METHOD AND SYSTEM FOR DISPLAY

(75) Inventors: Hsiu Ju TSAI, Hsinchu City (TW); Hsin Da Yeh, Hsinchu City (TW); Yuh Chuan Cheng, Hsinchu City (TW); Hsueh Ling Yu, Hsinchu City (TW)

Correspondence Address: EGBERT LAW OFFICES, 412 MAIN STREET, 7TH FLOOR, HOUSTON, TX, 77002, US

(73) Assignee: INDUSTRIAL TECHNOLOGY RESEARCH INSTITUTE, Hsinchu (TW)

(21) Appl. No.: 12/613,991

(22) Filed: Nov. 6, 2009

(30) Foreign Application Priority Data
Dec. 10, 2008 (TW) 097147946

(51) Int. Cl. G06K 9/00

(52) U.S. Cl. 382/100

(57) ABSTRACT

A ghost image inspection system comprises a carrier, a reflectance measurement apparatus, and a processing apparatus. The carrier is configured to support the electronic paper display, and the electronic paper display is configured to show a test pattern and at least one sub-frame. The test pattern has a plurality of optical states. The reflectance measurement apparatus is coupled to the carrier and is configured to measure reflectances of the test pattern and at least one sub-frame, and the processing apparatus is coupled to the reflectance measurement apparatus and is configured to determine whether the reflectance is worse than a threshold value of a ghost image index.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present disclosure relates to an inspection method and system for display, and more particularly, to an inspection method and system for the ghost image shown on an electronic paper display after updating images.

2. Description of Related Art Including Information Disclosed Under 37 CFR 1.97 and 37 CFR 1.98.

With the development of the display technology in recent years, new display materials are continually developed and applied. In contrast with popular flat panel displays, such as liquid crystal displays (LCDs), an electronic paper has paper-like characteristics and is thin, flexible, and easy to carry. An electronic paper display (e-paper display), including an electrophoretic display (EPD), presents a display image that is determined by the position of the charged particles encapsulated within micro-structures, including microcapsules or microcups, of the display. The electrophoretic display is one type of reflective display which could reflect an environmental light without requiring a built-in backlight. In addition, the electrophoretic display is one type of bi-stable display which could still hold an original display image after power is turned off and consumes power only when updating images, so as to reduce power consumption. Moreover, the electrophoretic display operates without a polarization plate, and thus it could have a higher reflectance with no viewing angle limitation for reading.

However, although the e-paper display has various features as mentioned above, a ghost image phenomenon affects the quality of the display frame and causes reader discomfort for reading or even display of incorrect information. The optical state of the e-paper display, i.e., the variation of gray levels, is determined by applying an electrical signal to both sides of the electrodes so as to drive the movement of the charged particles. Therefore, the final position of the charged particles due to the applying electrical signal determines the gray level of the display. The ghost image phenomenon is formed because the magnitude of the electrical signal cannot be predicted precisely, so that an inaccuracy exists between an expected gray level and a practical gray level. Generally, the inaccuracy between the expected gray level and the practical gray level is determined by many factors; for example, the movable distance of the charged particle may not be linear to the electrical signal and the reflectance degradation rate of the optical states often varies with time. Also, the influence of various applied factors, such as temperature, electrostatic force between particles, and gravity, results in the movement of the charged particles and causes the ghost image phenomenon.

US publication No. 2007/0164982 disclosed an electrophoretic display with uniform image stability regardless of initial optical states. Referring to FIG. 1, curves 100, 110, 120, and 130 show the brightness drop when a white optical stage is reached from white, light grey, dark grey, and black, respectively. For example, at time=200 sec, the brightness of the white state when reached from an initial state of black (curve 130) is lower than the brightness of the white state when reached from an initial state of dark grey (curve 120), and the latter is lower than the brightness of the white state when reached from an initial state of light grey (curve 110). As a result of the different reflectance degradation rates, the ghost image phenomenon occurs. Therefore, for avoiding the ghost image, at least one re-addressing pulse is added to an applying voltage waveform.

The ghost image phenomenon is an important factor affecting the image quality of the e-paper display. Therefore, there is a need to provide the e-paper display manufacturers an inspection method for the ghost image. The current inspection of the ghost image relies on quality control operators to inspect the image quality of the display one by one. Such method results in subjective judgment due to the variances in perception between different quality control operators, and thus affects the consistency and stability of the inspection quality. In addition, such method requires enormous time and labor cost. Therefore, it is desirable to provide an inspection method and system for e-paper displays to meet the requirement of the industry.

### BRIEF SUMMARY OF THE INVENTION

One embodiment of the present disclosure provides a ghost image inspection method for an electronic paper display, which comprises the steps of obtaining a threshold value of a ghost image index; showing at least one sub-frame on the electronic paper display; performing a reflectance measurement according to an optical state of the sub-frame; and checking whether the reflectance is worse than the threshold value of the ghost image index.

Another embodiment of the present disclosure provides a ghost image inspection system for an electronic paper display. The system comprises a carrier, a reflectance measurement apparatus, and a processing apparatus. The carrier is configured to support the electronic paper display, and the electronic paper display is configured to show a test pattern and at least one sub-frame. The test pattern has a plurality of optical states. The reflectance measurement apparatus is coupled to the carrier and is configured to measure reflectances of the test pattern and at least one sub-frame, and the processing apparatus is coupled to the reflectance measurement apparatus and is configured to check whether the reflectance is worse than a threshold value of a ghost image index.

### BRIEF DESCRIPTION OF THE SEVERAL VIEWS OF THE DRAWINGS

FIG. 1 is a graph, illustrating a decrease in relative brightness as a function of hold time disclosed in US publication No. 2007/0164982.

FIG. 2A is a flowchart illustrating an exemplary embodiment of an inspection method for an e-paper display.

FIG. 2B is a flowchart of an exemplary embodiment of step S21.

FIG. 2C is a flowchart of an exemplary embodiment of step S23.

FIG. 3 is a flowchart illustrating an exemplary embodiment for obtaining a threshold value of a ghost image index.

FIG. 4 shows a schematic view of the initial optical state of the sub-frame.

FIG. 5 illustrates a schematic view of a ghost image inspection system for an e-paper display in accordance with an exemplary embodiment.

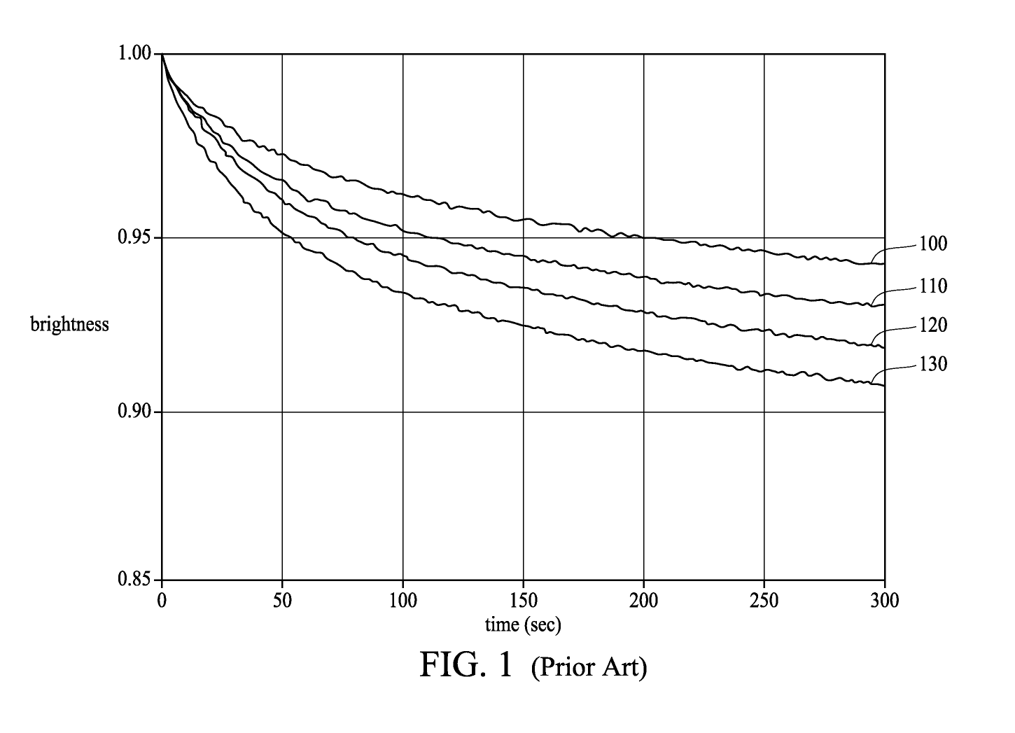

### DETAILED DESCRIPTION OF THE INVENTION

Exemplary embodiments would now be described more fully with reference to the accompanying drawings. The embodiments may, however, be embodied in many different forms and should not be construed as limited to the embodiments set forth herein. Rather, these embodiments are provided to enable this disclosure to fully and completely convey the scope of the embodiments to those skilled in the art.

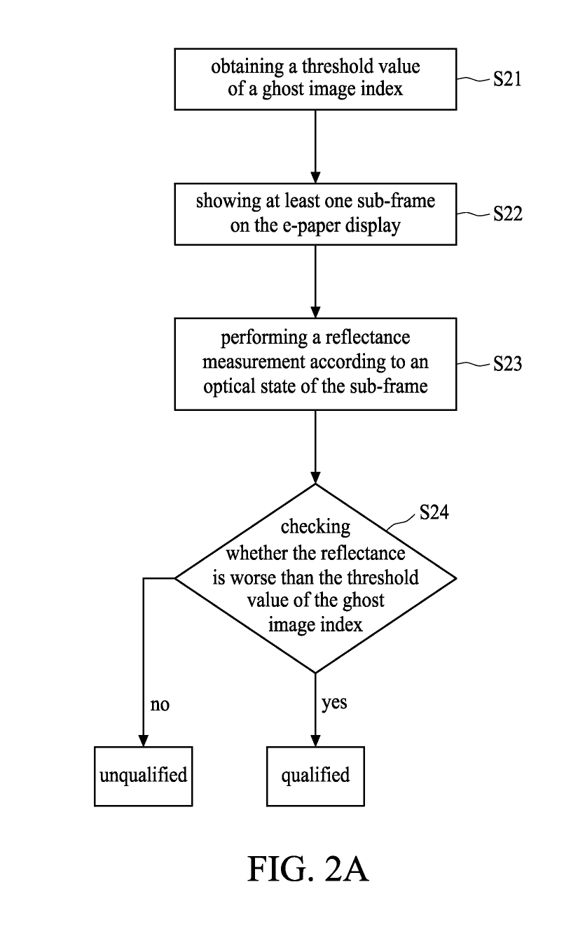

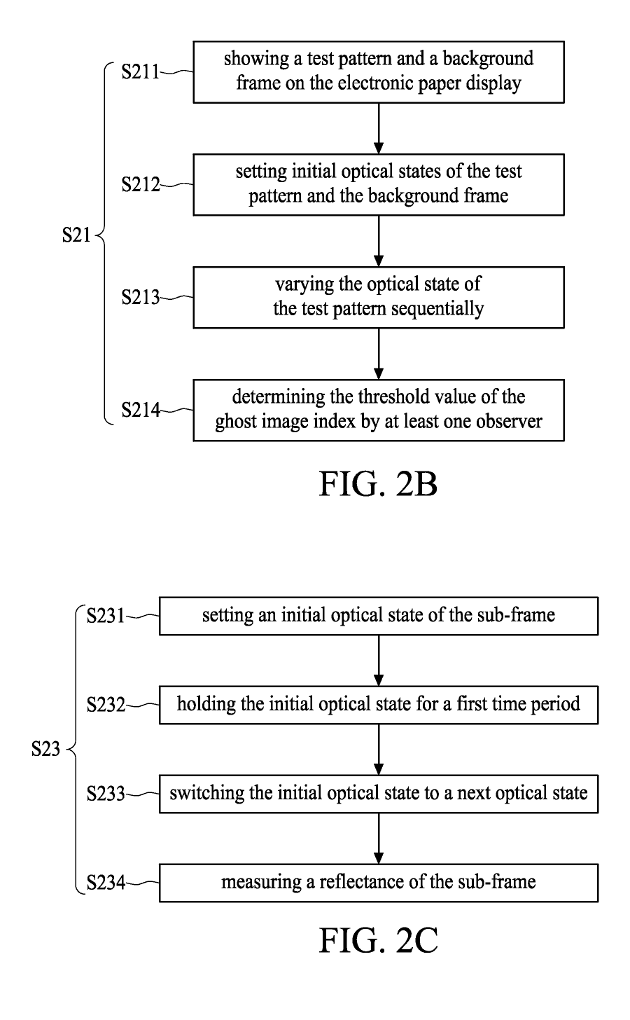

FIG. 2A is a flowchart illustrating an exemplary embodiment of an inspection method for an e-paper display. In step S21, a threshold value of a ghost image index is obtained. In step S22, at least one sub-frame is shown on the e-paper display. In step S23, a reflectance measurement is performed according to an optical state of the sub-frame, and in step S24, it is determined whether or not the reflectance is worse than the threshold value of the ghost image index.

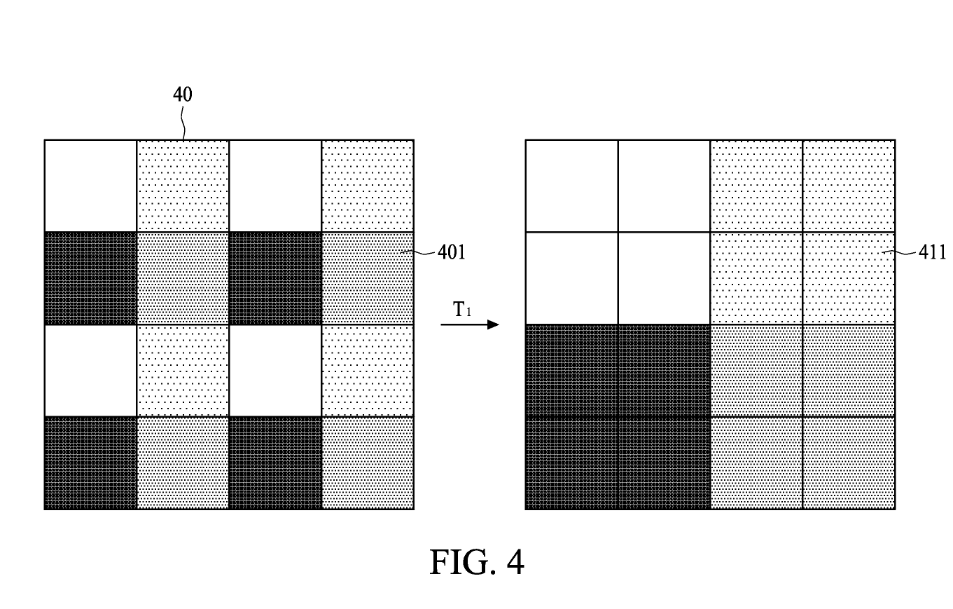

FIG. 2B illustrates an exemplary embodiment of step S21. In step S211, a test pattern and a background frame are shown on the e-paper display. In step S212, initial optical states of the test pattern and the background frame are set. In step S213, an optical state of the test pattern is sequentially varied, and in step S214, the threshold value of the ghost image index is determined by at least one observer. In step S211, the test pattern could be a pattern including a corner, such as an English letter, a polygon, or a cruciform pattern as shown in FIG. 4, which is easier for the observer to identify. In addition, in this embodiment, the charged particles are black and white particles, so there are four initial optical states including black, dark grey, light grey, and white. In other embodiments, the charged particles could be particles with different colors, or with other grey levels.

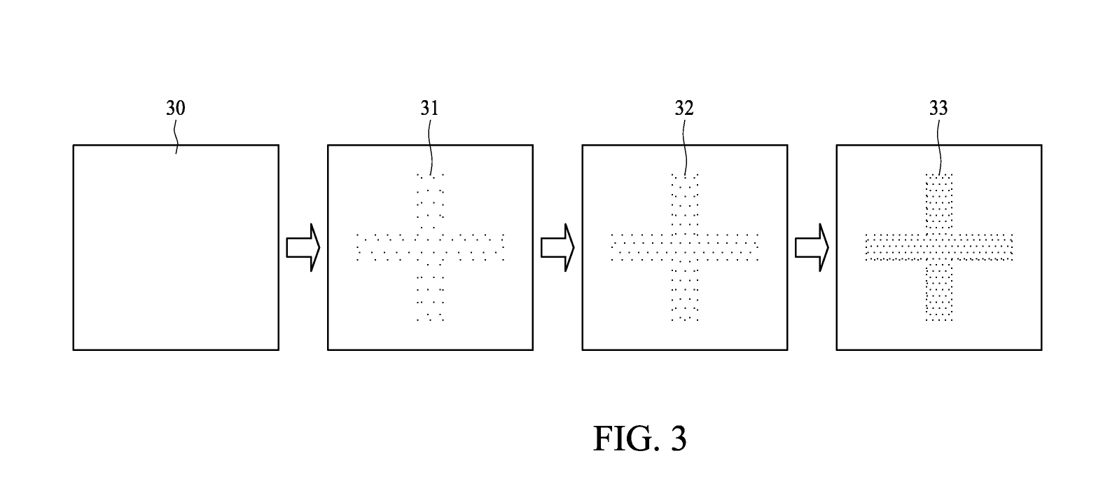

Referring to FIG. 3, an exemplary embodiment is introduced to describe the flowchart for obtaining a threshold value of a ghost image index. First, a test pattern is set to a cruciform pattern (step S211). Next, initial optical states of a background frame 30 and the test pattern are both set to a white state (step S212). Next, the optical state of the background frame 30 remains unchanged and the test pattern is sequentially varied from the white state to a light grey state (referring to steps S213 and 31 to 33). In step S213, the sequential variation of the optical state of the particle could achieve the conversion of the optical state of the particle by adjusting an electrical signal coupled to both sides of electrodes, for example, by gradually increasing the ratio or the amplitude of the pulse cycle to transform the optical state. In addition, during the sequentially varied optical state process, at least one observer performs a visual inspection to confirm whether the test pattern and the background frame could be distinguished. When the observer could distinguish the test pattern from the background frame by visual inspection, a reflectance of the test pattern is measured. The measured reflectance is a threshold reference value of the ghost image index where the optical state converts from light grey to white, and the reflectance thereof is represented as R_{(LIGHT GREY}_{_{—}}_{WHITE)}. Next, the threshold reference values inspected by different observers are summed and averaged for obtaining the threshold value of the ghost image index, which is represented as R_{—}_{^{AVG(LIGHT GREY}}_{—}_{^{WHITE)}} (referring to step S214). The conversion of optical states of the charge particles has the following types: white to light grey, where the threshold value is represented as R_{—}_{^{AVG(WHITE}}_{—}_{^{LIGHT GREY)}}; white to dark grey, where the threshold value is represented as R_{—}_{^{AVG(WHITE}}_{—}_{^{DARK GREY)}}; white to black, where the threshold value is represented as R_{—}_{^{AVG(WHITE}}_{^{—}}^{BLACK)}; light grey to white, where the threshold value is represented as R_{—}_{^{AVG(LIGHT GREY}}_{—}_{^{WHITE)}}; light grey to dark grey, where the threshold value is represented as R_{—}_{^{AVG(LIGHT GREY}}_{—}_{^{DARK GREY)}}; light grey to black, where the threshold value is represented as R_{—}_{^{AVG(LIGHT GREY}}_{—}_{^{BLACK)}}; dark grey to white, where the threshold value is represented as R_{—}_{^{AVG(DARK GREY}}_{—}_{^{WHITE)}}; dark grey to light grey, where the threshold value is represented as R_{—}_{^{AVG(DARK GREY}}_{—}_{^{LIGHT GREY)}}; dark grey to black, where the threshold value is represented as R_{—}_{^{AVG(DARK GREY}}_{—}_{^{BLACK)}}; black to white, where the threshold value is represented as R_{—}_{^{AVG(BLACK}}_{—}_{^{WHITE)}}; black to light grey, where the threshold value is represented as R_{—}_{^{AVG(BLACK}}_{—}_{^{LIGHT GREY)}}; and black to dark grey, where the threshold value is represented as R_{—}_{^{AVG(BLACK}}_{—}_{^{DARK GREY)}}.

In step S22, at least one sub-frame could be shown on the e-paper display to reduce the inspection time. Referring to FIG. 4, the frame of the e-paper display is divided into sixteen sub-frames for showing different optical states. FIG. 2C is an exemplary embodiment of step S23. In step S231, an initial optical state of a sub-frame is set. In step S232, the initial optical state holds for a time period T1. In step S233, the initial optical state is switched to a next optical state, and in step S234, a reflectance of the sub-frame is measured.

In step S232, the selection of the time period T1 is based on the update frequency of the frame where e-paper displays are applied in different occasions. For example, when the e-paper display is applied in electronic books, the update frequency of the frame is around several minutes per update, and when the e-paper display is applied in a store or in an exhibition, the update frequency of the frame is around several hours per update. As mentioned above, the reflectance degradation rate of the e-paper display frame varies with time, and thus the hold time T1 could be adjusted according to the applied occasion of the e-paper display for ensuring the stability of grey levels. Referring to FIG. 4, the initial optical state of the sub-frame 401 in the display frame 40 is dark grey. The sub-frame 401 is switched to a next optical state (light grey) after the hold time T1, and an e-paper display of the sub-frame 411 is measured immediately so as to determine whether the reflectance is greater than the aforementioned R_{—}_{^{AVG(DARK GREY}}_{—}_{^{LIGHT GREY)}} of the ghost image index. R_{—}_{^{AVG(BLACK}}_{—}_{^{WHITE)}}, R_{—}_{^{AVG(BLACK}}_{—}_{^{LIGHT GREY)}}, R_{—}_{^{AVG(BLACK}}_{—}_{^{DARK GREY)}}, R_{(DARK GREY}_{_{—}}_{WHITE)}, R_{(LIGHT GREY}_{_{—}}_{WHITE)}, R_{(DARK GREY}_{_{—}}_{LIGHT GREY)}, and R_{(LIGHT GREY}_{_{—}}_{WHITE)} correspond to the threshold values of the ghost image index illustrating conditions in which the relative dark optical states convert to the relative light optical states. Therefore, when the reflectance is greater than those threshold values, the e-paper display is qualified. Otherwise, the e-paper display is unqualified. R_{—}_{^{AVG(WHITE}}_{—}_{^{BLACK)}}, R_{—}_{^{AVG(LIGHT GREY}}_{—}_{^{BLACK)}}, R_{—}_{^{AVG(DARK GREY}}_{—}_{^{BLACK)}}, R_{(WHITE}_{_{—}}_{LIGHT GREY)}, R_{(WHITE}_{_{—}}_{DARK GREY)}, and R_{(LIGHT GREY}_{_{—}}_{DARK GREY)} correspond to the threshold values of the ghost image index illustrating conditions in which the relative light optical states convert to the relative dark optical states. Therefore, when the reflectance is smaller than those threshold values, the e-paper display is qualified. Otherwise, the e-paper display is unqualified.

In another exemplary embodiment of an inspection method for an e-paper display, to ensure the reflectance degradation rate of the e-paper display would not result in a ghost image phenomenon immediately or after a time period, after step S233 the display frame is held in the next optical state for a time period T2, and then a measurement step is performed (step S224). The selection of the time period T2 is adjusted according to the update frequency of the frame where e-paper displays are applied in different occasions.

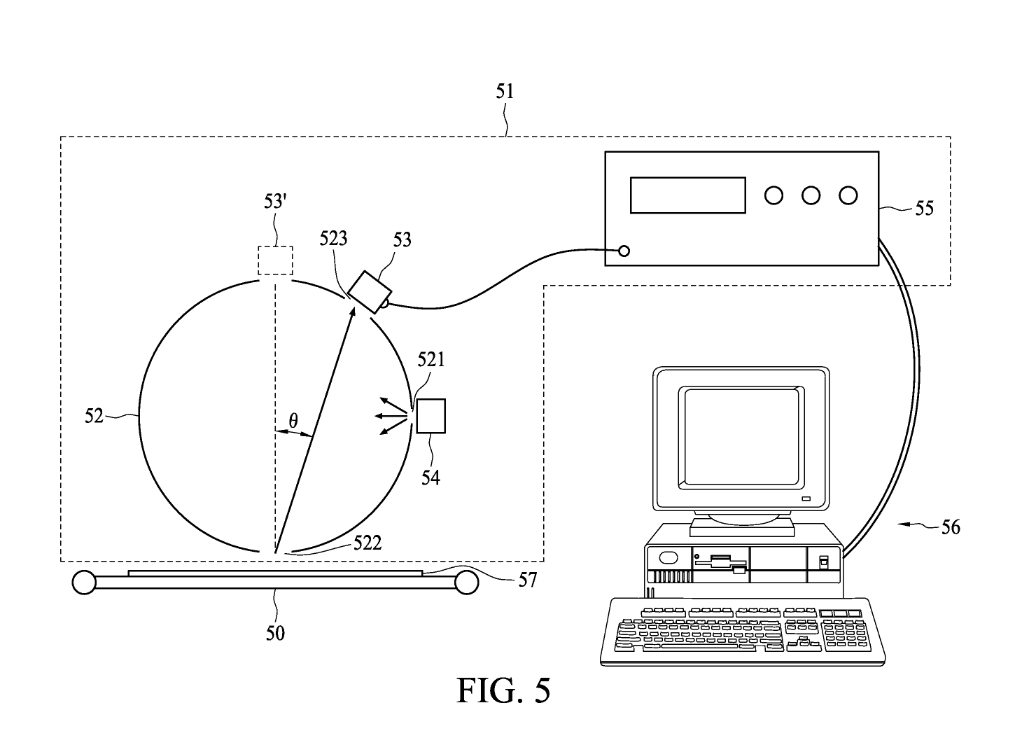

FIG. 5 illustrates a ghost image inspection system for an e-paper display in accordance with an exemplary embodiment. The ghost image inspection system comprises a carrier 50, a reflectance measurement apparatus 51 and a processing apparatus 56. The carrier 50 is configured to fix an e-paper display 57 and the e-paper display 57 is configured to show a test pattern and at least one sub-frame, wherein the test pattern has a plurality of optical states, and the plurality of optical states are sequentially varied from the relative dark optical states to the relative light optical states or from the relative light optical states to the relative dark optical states. The test pattern could be a pattern with a corner, such as an English letter, a polygon, or a cruciform pattern as shown in FIG. 4. In addition, the sub-frames could switch to next sub-frames after the hold time T1, and the selection of the hold time T1 is based on the update frequency of the frame where e-paper displays are applied in different occasions.

Referring to FIG. 5, the reflectance measurement apparatus 51 comprises an integral sphere 52, an optical detector 53, a light source 54, and a signal conversion apparatus 55. The integral sphere 52 has a first opening 521, a second opening 522, and a third opening 523. The second opening 522 is attached tightly to a surface of the e-paper display 57. The first opening 521 directs light from the light source 54 into the integral sphere 52, and reflected light is generated when the light irradiates on the surface of the e-paper display 57 via the second opening 522. Subsequently, the reflected light from the e-paper display 57 is transmitted to the optical detector 53 via the third opening 523. The optical detector 53 is configured to convert the light signal to an electrical signal. The electrical signal is then read by the signal conversion apparatus 55, such as an ammeter, and outputted to the processing apparatus 56 for performing data analysis so as to obtain a reflectance of the display frame of the e-paper display 57. In addition, the optical detector 53 could move with an angle θ to simulate conditions where users observe the display frame from different viewing angles. The processing apparatus 56 is configured to receive the aforementioned threshold value of the ghost image index and compare the value with the reflectance of the sub-frame after switching so as to determine whether the e-paper display is qualified or unqualified. In another exemplary embodiment, a reflectance measurement of the switched sub-frame could be performed after the hold time T2, and the measurement is then input to the processing apparatus 56 to be compared with the aforementioned threshold value of the ghost image index. The selection of the time period T2 is according to the update frequency of the frame where e-paper displays are applied in different occasions.

In yet another exemplary embodiment, the measurement of the reflectance could use an image capturing apparatus, such as a CCD sensing apparatus or a CMOS sensing apparatus, to capture the display frame, wherein the display frame has a plurality of pixels. Subsequently, a processing apparatus, such as an image processing apparatus, is used to calculate the reflectance of the grey level of the corresponding pixels. The e-paper display could be an electrophoretic display in one exemplary embodiment.

The above-described exemplary embodiments are intended to be illustrative only. Those skilled in the art may devise numerous alternative embodiments without departing from the scope of the following claims.

1. A ghost image inspection method for an electronic paper display, comprising the steps of:
obtaining a threshold value of a ghost image index;
showing at least one sub-frame on the electronic paper display;
performing a reflectance measurement according to an optical state of the sub-frame; and
checking whether reflectance is worse than the threshold value of the ghost image index.

2. The ghost image inspection method of claim 1, wherein the optical state is a black state, a dark grey state, a light grey state, or a white state.

3. The ghost image inspection method of claim 1, wherein the optical state is colored or another grey level.

4. The ghost image inspection method of claim 1, wherein a test pattern is comprised of a pattern with a corner.

5. The ghost image inspection method of claim 1, wherein the electronic paper display shows sixteen sub-frames.

6. The ghost image inspection method of claim 1, wherein the electronic paper display is comprised of an electrophoretic display.

7. The ghost image inspection method of claim 1, wherein the step of obtaining a threshold value of a ghost image index comprises:
showing a test pattern and a background frame on the electronic paper display;
setting initial optical states of the test pattern and the background frame;
varying the optical state of the test pattern sequentially; and
determining the threshold value of the ghost image index by at least one observer.

8. The ghost image inspection method of claim 7, wherein the reflectance is checked to determine whether it is smaller than the threshold value of the ghost image index when the optical state is sequentially varied from a relative light state to a relative dark state.

9. The ghost image inspection method of claim 7, wherein the reflectance is checked to determine whether it is larger than the threshold value of the ghost image index when the optical state is sequentially varied from the relative dark state to the relative light state.

10. The ghost image inspection method of claim 7, wherein the sequential variation of the optical state is achieved by adjusting an electrical signal coupled to both sides of electrodes.

11. The ghost image inspection method of claim 10, wherein the adjustment of the electrical signal is according to a period of a pulse cycle.

12. The ghost image inspection method of claim 10, wherein the adjustment of the electrical signal is according to an amount of amplitude.

13. The ghost image inspection method of claim 7, wherein the threshold value of the ghost image index is comprised of a value that averages a summed value from threshold reference values determined by the at least one observer.

14. The ghost image inspection method of claim 1, wherein the step of performing a reflectance measurement according to an optical state of the sub-frame comprises:
setting an initial optical state of the sub-frame;
holding the initial optical state for a first time period;
switching the initial optical state to a next optical state; and
measuring a reflectance of the sub-frame.

15. The ghost image inspection method of claim 14, wherein the selection of the first time period is according to an update frequency of the frame where the electronic paper display is applied in different occasions.

16. The ghost image inspection method of claim 14, further comprising holding the next optical state for a second time period after the step of switching the initial optical state to a next optical state.

17. The ghost image inspection method of claim 16, wherein the selection of the second time period is according to an update frequency of the frame where the electronic paper display is applied in different occasions.

18. A ghost image inspection system for an electronic paper display, comprising:
a carrier configured to support the electronic paper display, wherein the electronic paper display is configured to show a test pattern and wherein at least one sub-frame and the test pattern has a plurality of optical states;
a reflectance measurement apparatus coupled to the carrier and configured to measure reflectances of the test pattern and at least one sub-frame; and
a processing apparatus coupled to the reflectance measurement apparatus and configured to determine whether the reflectance is worse than a threshold value of a ghost image index.

19. The ghost image inspection system of claim 18, wherein the electronic paper display is comprised of an electrophoretic display.

20. The ghost image inspection system of claim 18, wherein the at least one sub-frame is switched according to a third time period and a measurement of the reflectance of the sub-frame is performed according to an optical state of the switched sub-frame.

21. The ghost image inspection system of claim 18, wherein the at least one sub-frame is switched according to a third time period and the measurement of the reflectance of the switched frame is performed after a fourth time period.

22. The ghost image inspection system of claim 18, wherein the reflectance measurement apparatus comprises an integral sphere, an optical detector, a light source, and a signal conversion apparatus, wherein the integral sphere has a first opening, a second opening, and a third opening, the first opening is coupled to the light source, the second opening is coupled to the electronic paper display, the third opening is coupled to the optical detector, and the signal conversion apparatus is coupled between the optical detector and the processing apparatus.

23. The ghost image inspection system of claim 18, wherein the threshold value of the ghost image index is comprised of a value that averages a summed value from the reflectances of the plurality of optical states of the test pattern.

24. The ghost image inspection system of claim 18, wherein the test pattern is comprised of a pattern with a corner.

25. The ghost image inspection system of claim 20, wherein the third time period is according to an update frequency of the frame where the electronic paper display is applied in different occasions.

26. The ghost image inspection system of claim 21, wherein the fourth time period is according to the update frequency of the frame where the electronic paper display is applied in different occasions.

27. The ghost image inspection method of claim 18, wherein the reflectance measurement apparatus comprises an image capturing apparatus and an image processing apparatus.
